(19) United States
(12) Patent Application Publication
(10) Pub. No.: US 2021/0105411 A1
(43) Pub. Date: Apr. 8, 2021

(54) DETERMINATION DEVICE, PHOTOGRAPHING SYSTEM, MOVABLE BODY, COMPOSITE SYSTEM, DETERMINATION METHOD, AND PROGRAM

(71) Applicant: SZ DJI TECHNOLOGY CO., LTD., Shenzhen (CN)

(72) Inventor: Kenichi HONJO, Tokyo (JP)

(21) Appl. No.: 17/122,948

(22) Filed: Dec. 15, 2020

Related U.S. Application Data
(63) Continuation of application No. PCT/CN2019/091742, filed on Jun. 18, 2019.

(30) Foreign Application Priority Data
Jun. 19, 2018 (JP) 2018-116418

(51) Int. Cl. H04N 5/232; B64C 39/02

(52) U.S. Cl. CPC H04N 5/232121; B64C 2201/127; B64C 39/024; H04N 5/23296

(57) ABSTRACT

A determination device includes a processor and a storage device storing instructions that, when executed by the processor, cause the processor to obtain a plurality of focus distances corresponding to a plurality of shooting targets included in a shooting range of a photographing device, and determine a target distance between the photographing device and the plurality of shooting targets for the photographing device to shoot the plurality of shooting targets based on the plurality of focus distances.

### CROSS-REFERENCE TO RELATED APPLICATIONS

This application is a continuation of International Application No. PCT/CN2019/091742, filed Jun. 18, 2019, which claims priority to Japanese Application No. 2018-116418, filed Jun. 19, 2018, the entire contents of both of which are incorporated herein by reference.

### TECHNICAL FIELD

The present disclosure relates to a determination device, a photographing system, a movable body, a composite system, a determination method and a program.

### BACKGROUND

Patent Document 1 discloses extracting a still image focused at a specified area from a plurality of images included in dynamic image data. Patent Document 2 discloses that from a plurality of image data captured while a focus position is shifted by a preset amount, image data to be combined is selected based on a shift amount of the focus position and a resolution of the image data to combine the selected multiple images data.

Patent Document 1: International Publication No. 2017/006538.

Patent Document 2: Japanese Publication No. 2015-231058.

According to the characteristics of a lens system included in a photographing device, when a focus distance changes, a magnification of a shooting target imaged at an image plane may change. When the photographing device shoots multiple images while changing the focus distance, it is desirable to suppress a size change of the shooting target included in each of the multiple images.

### SUMMARY

In accordance with the disclosure, there is provided a determination device including a processor and a storage device storing instructions that, when executed by the processor, cause the processor to obtain a plurality of focus distances corresponding to a plurality of shooting targets included in a shooting range of a photographing device, and determine a target distance between the photographing device and the plurality of shooting targets for the photographing device to shoot the plurality of shooting targets based on the plurality of focus distances.

Also in accordance with the disclosure, there is provided a photographing system including a photographing device and a determination device. The photographing device includes a lens system with a focus lens. The determination device includes a processor and a storage device storing instructions that, when executed by the processor, cause the processor to obtain a plurality of focus distances corresponding to a plurality of shooting targets included in a shooting range of the photographing device, and determine a target distance between the photographing device and the plurality of shooting targets for the photographing device to shoot the plurality of shooting targets based on the plurality of focus distances.

Also in accordance with the disclosure, there is provided a movable body including a photographing system and a controller. The photographing system includes a photographing device and a determination device. The photographing device includes a lens system with a focus lens. The determination device includes a processor and a storage device storing instructions that, when executed by the processor, cause the processor to obtain a plurality of focus distances corresponding to a plurality of shooting targets included in a shooting range of the photographing device, and determine a target distance between the photographing device and the plurality of shooting targets for the photographing device to shoot the plurality of shooting targets based on the plurality of focus distances. The controller is configured to control the movable body to move so that a distance between the photographing device and the plurality of shooting target is the target distance.

Also in accordance with the disclosure, there is provided a composite system including a processor and a storage device storing instructions that, when executed by the processor, cause the processor to obtain a plurality of focus distances corresponding to a plurality of shooting targets included in a shooting range of a photographing device, determine a target distance between the photographing device and the plurality of shooting targets for the photographing device to shoot the plurality of shooting targets based on the plurality of focus distances, control the photographing device to shoot the plurality of shooting targets at each of the plurality of focus distances in a state where a distance between the photographing device and the plurality of shooting targets is set as the target distance to obtain a plurality of images, and combine the plurality of images.

### BRIEF DESCRIPTION OF THE DRAWINGS

FIG. 1 is a schematic diagram showing an unmanned aerial vehicle (UAV) and a remote operation device according to an embodiment of the disclosure.

FIG. 2 is a diagram showing functional blocks of a UAV according to an embodiment of the disclosure.

FIG. 3 is a diagram showing a positional relationship between a plurality of shooting targets and a photographing device according to an embodiment of the disclosure.

FIG. 4 is an example of an image including the plurality of shooting targets in the positional relationship shown in FIG. 3.

FIG. 5 is a diagram showing a correspondence relationship between a change of a focus distance of a photographing device over time and a change of a distance between a closest shooting target and the photographing device over time according to an embodiment of the disclosure.

FIG. 6 is a diagram showing a relationship between a contrast evaluation value and a focus distance according to an embodiment of the disclosure.

FIG. 7 is a diagram showing a scenario where a photographing device shoots a plurality of images while a UAV is moving.

FIG. 8 is a diagram showing a scenario where a composite image is generated from a plurality of images shot by a photographing device.

FIG. 9 is a flowchart of a shooting process of a photographing device mounted at a UAV according to an embodiment of the disclosure.

FIG. 10 is a diagram of a hardware configuration according to an embodiment of the disclosure.

### DETAILED DESCRIPTION OF THE EMBODIMENTS

The technical solutions in the example embodiments of the present disclosure will be described clearly with reference to the accompanying drawings. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure.

Various embodiments of the present disclosure are described with reference to flowcharts and block diagrams. A block may represent a stage of a process of performing operations or a “unit” of a device that performs operations. The specific stages and “units” can be implemented by programmable circuits and/or processors. A dedicated circuit may include a digital and/or an analog circuit, or may include an integrated circuit (IC) and/or a discrete circuit. A programmable circuit may include a reconfigurable circuit. The reconfigurable circuit may include a circuit with a logic operation such as logic AND, logic OR, logic XOR, logic NAND, logic NOR, or another logic operation, a flip-flop, a register, a field programmable gate array (FPGA), a programmable logic array (PLA)), or another memory component.

The computer-readable medium may include any tangible device that can store instructions to be executed by a suitable device. As a result, the computer-readable medium with instructions stored is provided with a product including instructions that can be executed to create means for performing operations specified by the flowchart or the block diagram. The computer-readable medium may include electronic storage media, magnetic storage media, optical storage media, electromagnetic storage media, semiconductor storage media, or the like. As a more specific example of the computer-readable medium, it may include a floppy disk (registered trademark), a hard disk, a random-access memory (RAM), a read-only memory (ROM), an erasable programmable read-only memory (EPROM or a flash memory), an electrically erasable programmable read-only memory (EEPROM), a static random access memory (SRAM), a compact disc read-only memory (CD-ROM), a digital versatile disc (DVD), a Blu-ray (RTM) disc, a memory stick, or an integrated circuit card, etc.

The computer-readable instructions may include any one of source code or object code described in any combination of one or more programming languages. The source code or object code can include a programming language such as assembly instructions, instruction set architecture (ISA) instructions, machine instructions, machine-related instructions, microcode, firmware instructions, status setting data, or object-oriented programming languages such as Smalltalk, JAVA (registered trademark), C++, etc., or “C” programming language or similar programming languages. The computer-readable instructions may be provided locally or via a wide area network (WAN) such as a local area network (LAN) or an internet to a processor or a programmable circuit of a general-purpose computer, a special-purpose computer, or other programmable data processing device. The processor or programmable circuit can execute computer-readable instructions to create means for performing the operations specified in the flowchart or block diagram. Examples of processors include computer processors, processing units, microprocessors, digital signal processors, controllers, microcontrollers, and so on.

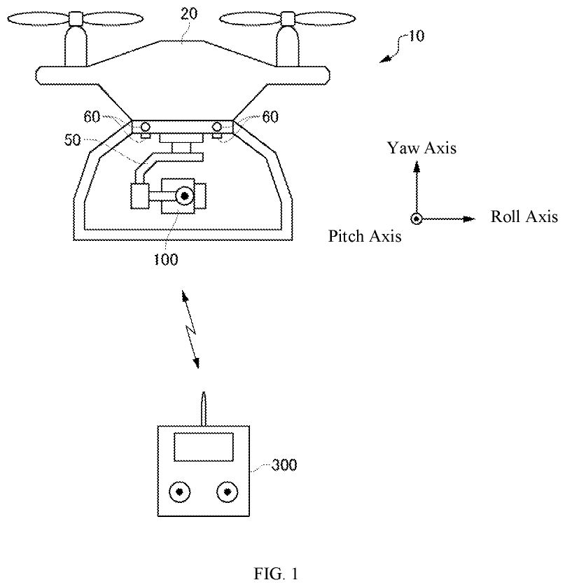

FIG. 1 is a schematic diagram showing an unmanned aerial vehicle (UAV) 10 and a remote operation device 300 according to an embodiment of the disclosure. The UAV 10 includes a UAV body 20, a gimbal 50, a plurality of photographing devices 60, and a photographing device 100. The gimbal 50 and the photographing device 100 are an example of a photographing system. The UAV 10 is an example of a movable body, which can include a flight body movable in the air, a vehicle movable on the ground, or a ship movable on water. Flight bodies movable in the air include not only UAVs, but also other aircrafts, airships, or helicopters that can move in the air.

The UAV body 20 includes a plurality of rotors. The plurality of rotors are an example of a propulsion unit. The UAV body 20 causes the UAV 10 to fly by controlling the rotation of the plurality of rotors. The UAV body 20 uses, for example, four rotors to enable the UAV 10 to fly. The number of rotors is not limited to four. Further, the UAV 10 may also be a fixed-wing aircraft without rotors.

The photographing device 100 may be an imaging camera that shoots an object included in a desired shooting range. The gimbal 50 rotatably supports the photographing device 100. The gimbal 50 is an example of a support mechanism. For example, the gimbal 50 may use an actuator to support the photographing device 100 rotatably around a pitch axis. The gimbal 50 may use actuators to further support the photographing device 100 rotatably around a roll axis and a yaw axis. The gimbal 50 can change an attitude of the photographing device 100 by rotating the photographing device 100 around at least one of the yaw axis, the pitch axis, or the roll axis.

The plurality of photographing devices 60 may be sensing cameras that shoot surroundings of the UAV 10 in order to control the flight of the UAV 10. The two photographing devices 60 may be provided at a nose, that is, the front of the UAV 10. Furthermore, the other two photographing devices 60 may be provided at a bottom surface of the UAV 10. The two photographing devices 60 on the front side may be paired to function as a stereo camera. The two photographing devices 60 on the bottom side may also be paired to function as a stereo camera. The photographing device 60 can measure an existence of an object included in a shooting range of the photographing device 60 and a distance to the object. The photographing device 60 is an example of a measuring device for measuring an object existing in a shooting direction of the photographing device 100. The measuring device may also be another sensor, for example, an infrared sensor or an ultrasonic sensor, etc. for measuring an object existing in the shooting direction of the photographing device 100. Three-dimensional spatial data around the UAV 10 can be generated from images shot by the plurality of photographing devices 60. Further, the number of photographing devices 60 included in the UAV 10 is not limited to four. The UAV 10 may include at least one photographing device 60. The UAV 10 may include at least one photographing device 60 at the nose, a tail, a side surface, a bottom surface, or a top surface of the UAV 10, respectively. An angle of view of the photographing device 60 may be greater than an angle of view of the photographing device 100. The photographing device 60 may have a single focus lens or a fisheye lens.

The remote operation device 300 communicates with the UAV 10 to remotely operate the UAV 10. The remote operation device 300 can wirelessly communicate with the UAV 10. The remote operation device 300 transmits to the UAV 10 instruction information indicating various instructions related to the movement of the UAV 10 such as ascending, descending, accelerating, decelerating, going forward, going backward, or rotating. The instruction information may include instruction information to raise a height of the UAV 10. The instruction information may show the height at which the UAV 10 should be located. The UAV 10 moves to the height indicated by the instruction information received from the remote operation device 300. The instruction information may include an ascending instruction to raise the UAV 10. UAV 10 ascends while receiving the ascending instruction. When the height of the UAV 10 has reached an upper limit of the height, the UAV 10 can restrict the ascending even if the ascending instruction is received.

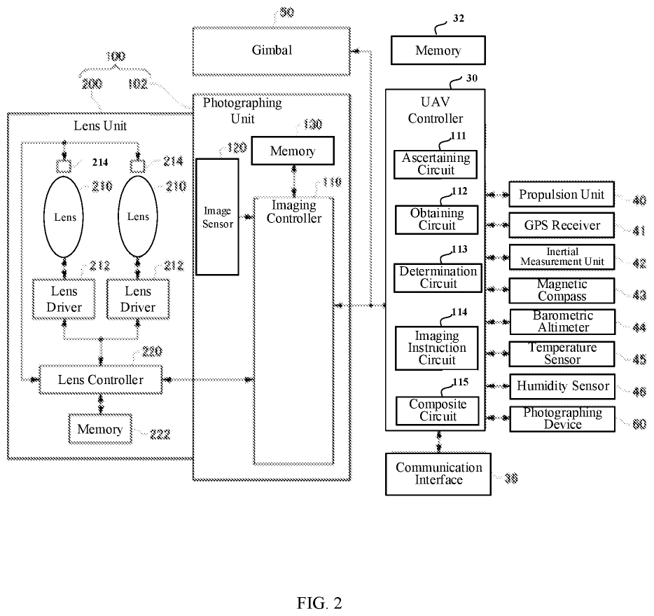

FIG. 2 shows functional blocks of the UAV 10 according to an embodiment of the disclosure. The UAV 10 includes a UAV controller 30, a memory 32, a communication interface 36, a propulsion unit 40, a GPS receiver 41, an inertial measurement unit (IMU) 42, a magnetic compass 43, a barometric altimeter 44, a temperature sensor 45, a humidity sensor 46, a gimbal 50, a photographing device 60 and a photographing device 100.

The communication interface 36 communicates with other devices such as the remote operation device 300. The communication interface 36 may receive instruction information including various instructions to the UAV controller 30 from the remote operation device 300. The memory 32 stores programs that the UAV controller 30 uses to control the propulsion unit 40, the GPS receiver 41, the IMU 42, the magnetic compass 43, the barometric altimeter 44, the temperature sensor 45, the humidity sensor 46, the gimbal 50, the photographing device 60, and the photographing device 100. The memory 32 may be a computer-readable recording medium, and may include at least one of an SRAM, a DRAM, an EPROM, an EEPROM, or a flash memory such as a USB memory. The memory 32 may be provided inside the UAV body 20. The memory may be configured to be detachable from the UAV body 20.

The UAV controller 30 may control a flight and shooting of the UAV 10 in accordance with a program stored in the memory 32. The UAV controller 30 may include a microprocessor such as a CPU or an MPU, a microcontroller such as an MCU, or the like. The UAV controller 30 may control the flight and shooting of the UAV 10 in accordance with instructions received from the remote operation device 300 via the communication interface 36. The propulsion unit 40 propels the UAV 10. The propulsion unit 40 includes a plurality of rotors and a plurality of drive motors that rotate the plurality of rotors. The propulsion unit 40 rotates the plurality of rotors via the plurality of drive motors according to an instruction from the UAV controller 30 to cause the UAV 10 to fly. The UAV controller 30 is an example of a third controller.

The GPS receiver 41 receives a plurality of signals indicating the time transmitted from a plurality of GPS satellites. The GPS receiver 41 calculates a position (latitude and longitude) of the GPS receiver 41, that is, a position (latitude and longitude) of the UAV 10, based on the received plurality of signals. The IMU42 detects an attitude of the UAV 10. The IMU 42 detects accelerations in directions of three axes of front to back, left to right, and up to down, and angular velocities in directions of three axes of a pitch axis, a roll axis, and a yaw axis of the UAV 10 as the attitude of the UAV 10. The magnetic compass 43 detects an orientation of a nose of the UAV 10. The barometric altimeter 44 detects a flying height of the UAV 10. The barometric altimeter 44 detects an air pressure around the UAV 10 and converts the detected air pressure to a height to detect the height. The temperature sensor 45 detects a temperature around the UAV 10. The humidity sensor 46 detects a humidity around the UAV 10.

The photographing device 100 includes a photographing unit 102 and a lens unit 200. The lens unit 200 is an embodiment of a lens device. The photographing unit 102 includes an image sensor 120, an imaging controller 110, and a memory 130. The image sensor 120 may include CCD or CMOS. The image sensor 120 shoots optical images formed through a plurality of lenses 210, and outputs the shot images to the imaging controller 110. The imaging controller 110 may be constituted by a microprocessor such as a CPU or an MPU, a microcontroller such as an MCU, or the like. The imaging controller 110 may control the photographing device 100 in accordance with an operation instruction of the photographing device 100 from the UAV controller 30. The memory 130 may be a computer-readable recording medium, and may include at least one of an SRAM, a DRAM, an EPROM, an EEPROM, or a flash memory such as a USB memory. The memory 130 stores programs that the imaging controller 110 uses to control the image sensor 120 and the like. The memory 130 may be provided inside a housing of the photographing device 100. The memory 130 may be configured to be detachable from the housing of the photographing device 100.

The lens unit 200 includes a plurality of lenses 210, a plurality of lens drivers 212, and a lens controller 220. The plurality of lenses 210 may function as focusing lenses. The lens unit 200 may be a single focus lens. At least a part of or the entire plurality of lenses 210 are configured to be movable along an optical axis. The lens unit 200 may be an interchangeable lens that is provided to be detachable from the photographing unit 102. The lens driver 212 moves at least a part of or the entire plurality of lenses 210 along the optical axis through a mechanism member such as a cam ring. The lens driver 212 may include an actuator and the actuator may include a stepper motor. The lens controller 220 drives the lens driver 212 according to a lens control command from the photographing unit 102, and moves one or more lenses 210 along the optical axis through a mechanism member. The lens control command may be a focus control command.

The lens unit 200 further includes a memory 222 and a position sensor 214. The lens controller 220 controls the movement of the lens 210 along the optical axis through the lens driver 212 according to a lens operation command from the photographing unit 102. Some or all of the plurality of lenses 210 move along the optical axis. The lens controller 220 performs a focus action by moving at least one of the lenses 210 along the optical axis. The position sensor 214 detects a position of the lens 210. The position sensor 214 can detect a current focus position.

The lens driver 212 may include a shake correction mechanism. The lens controller 220 may move the lens 210 in a direction along the optical axis or a direction perpendicular to the optical axis via the shake correction mechanism to perform shake correction. The lens driver 212 may drive the shake correction mechanism by a stepper motor to perform shake correction. Further, the shake correction mechanism may be driven by a stepper motor to move the image sensor 120 in a direction along the optical axis or a direction perpendicular to the optical axis to perform shake correction.

The memory 222 stores control values of the plurality of lenses 210 moved via the lens driver 212. The memory 222 may include at least one of an SRAM, a DRAM, an EPROM, an EEPROM, or a flash memory such as a USB memory.

In the photographing device 100 mounted at the UAV 10 as described above, the photographing device 100 shoots a plurality of images while changing the focus distance of the photographing device 100. The focus distance is a distance from the photographing device 100 to a shooting target in a focus state. The focus state is, for example, a state in which a contrast evaluation value of an area including the shooting target of interest in an image shot by the photographing device 100 is greater than or equal to a preset value. The focus distance can be changed by changing the lens position of the focus lens.

Among lens systems included in the photographing device 100, there is a lens system that changes a magnification of a shooting target imaged at the image plane due to a change in the focus distance. In a scenario where the photographing device 100 including such a lens system shoots multiple images while changing the focus distance, a size of the shooting target included in each of the multiple images may change. For example, when a plurality of images shot with different focus distances are combined, if the sizes of the shooting target in various images are different, an appropriate composite image may not be obtained.

Therefore, according to the photographing device 100 of the embodiments, in consideration of a magnification change along with a change in the focus distance, the UAV 10 is moved relative to the shooting target to change a distance between the shooting target and the photographing device 100. Therefore, a change in the size of the shooting target included in each of the plurality of images shot at different focus distances is suppressed.

The UAV controller 30 includes an ascertaining circuit 111, an obtaining circuit 112, a determination circuit 113, an imaging instruction circuit 114, and a composite circuit 115. Further, devices other than the UAV controller 30 may include at least one of the ascertaining circuit 111, the obtaining circuit 112, the determination circuit 113, the imaging instruction circuit 114, or the composite circuit 115. For example, the imaging controller 110 or the remote operation device 300 may include at least one of the ascertaining circuit 111, the obtaining circuit 112, the determination circuit 113, the imaging instruction circuit 114, or the composite circuit 115.

The UAV controller 30 ascertains respective focus distances to focus on each of a plurality of shooting targets included in the shooting area of the photographing device 100. In order to ascertain the focus distance, the imaging instruction circuit 114 changes the position of the focus lens of the photographing device 100 while maintaining the photographing device 100 at a first position, also referred to as an “initial device position,” and cause the photographing device 100 to shoot a plurality of images during the change of the lens position.

The UAV controller 30 may maintain the photographing device 100 at the first position by hovering the UAV 10 at the first position. The imaging instruction circuit 114 moves the focus lens from an infinity side to a closest side through the imaging controller 110 and the lens controller 220 while the UAV 10 is hovering. The imaging instruction circuit 114 causes the photographing device 100 to shoot a plurality of images while the focus lens moves from the infinity side to the closest side.

The ascertaining circuit 111 ascertains a plurality of focus distances for a plurality of shooting targets based on a plurality of images shot in a state where the positions of the focus lenses are different. The ascertaining circuit 111 obtains a contrast evaluation value of each of a plurality of images shot during the movement of the focus lens. The ascertaining circuit 111 can obtain a contrast evaluation value of each area of a plurality of areas constituting the image. The ascertaining circuit 111 ascertains a focus distance corresponding to a lens position of the focus lens where the contrast evaluation value reaches a peak. If there is an area where the contrast evaluation value reaches the peak among a plurality of areas in the image, the ascertaining circuit 111 may ascertain the focus distance corresponding to the lens position of the focus lens when the image was shot.

For example, the ascertaining circuit 111 can ascertain a focus distance by referring to a table that associates the lens position of the focus lens with the focus distance. The ascertaining circuit 111 can obtain a result of a contrast autofocus processing performed by the imaging controller 110. The ascertaining circuit 111 can ascertain a focus distance corresponding to the lens position of the focus lens where the contrast evaluation value reaches a peak based on the result. Further, the ascertaining circuit 111 may include an imaging controller 110.

The obtaining circuit 112 obtains a plurality of focus distances corresponding to a plurality of shooting targets included in the shooting range of the photographing device 100. The obtaining circuit 112 may obtain the respective focus distances, which are ascertained by the ascertaining circuit 111 and correspond to the lens positions of the respective focus lenses where the contrast evaluation value reaches the peak, as the plurality of focus distances corresponding to the plurality of shooting targets.

The determination circuit 113 determines a distance, also referred to as a “target distance,” between the photographing device 100 and the plurality of shooting targets when the photographing device 100 shoots the plurality of shooting targets based on the plurality of focus distances. In order to suppress a change in the size of the shooting target included in the plurality of images shot at the plurality of focus distances, the determination circuit 113 may determine the distances between the photographing device 100 and the plurality of shooting targets. The determination circuit 113 may determine the distances between the photographing device 100 and the plurality of shooting targets so as not to change the size of the same shooting target included in the plurality of images shot at the plurality of focus distances.

When the photographing device 100 includes a lens system where the magnification increases with increasing the focus distance, the determination circuit 113 may determine that a distance between the photographing device 100 and the plurality of shooting targets when a shooting target farther from the photographing device 100 among the plurality of shooting targets is shot is longer. When the photographing device 100 includes a lens system where the magnification decreases with increasing the focus distance, the determination circuit 113 may determine that a distance between the photographing device 100 and the plurality of shooting targets when a shooting target farther from the photographing device 100 among the plurality of shooting targets is shot is shorter.

The determination circuit 113 may decrease a difference between the distance between the photographing device 100 and the plurality of shooting targets when a shooting target closer to the photographing device 100 among the plurality of shooting targets is shot, and a distance between the first position of the photographing device 100 at the position with the ascertained focus distance and the plurality of shooting targets. The determination circuit 113 may determine the distance between the photographing device 100 and the plurality of shooting targets when a shooting target closer to the photographing device 100 among the plurality of shooting targets is shot as the distance between the first position of the photographing device 100 at the position with the ascertained focus distance and the plurality of shooting targets.

The memory 130 or the memory 32 may store a table that represents a relationship between the focus distance corresponding to the characteristics of the lens system included in the photographing device 100 and the distance from the photographing device 100 while shooting to the shooting target. The determination circuit 113 may refer to the table to determine the distances between the photographing device 100 and the plurality of shooting targets when the photographing device 100 shoots the plurality of shooting targets. The table may include, for example, the distance that should be determined by the determination circuit 113 for each in-focus distance. The memory 32 or the memory 130 may store a table of each focus distance of the closest shooting target. The closest distance is a distance from the photographing device 100 to the closest shooting target. For example, the determination circuit 113 may refer to the table and determine the distances corresponding to the focus distances of the shooting targets other than the shooting target at the closest distance.

The imaging instruction circuit 114 may make the photographing device 100 shoot the plurality of shooting targets at each of the plurality of focus distances obtained by the obtaining circuit 112 in a state where the distance between the photographing device 100 and the plurality of shooting targets is set as the distance determined by the determination circuit113. The imaging instruction circuit 114 may, according to a distance determined by the determination circuit 113, fine-tune the focus distance within an allowable range of the magnification change when the photographing device 100 shoot at the distance. The imaging instruction circuit 114 is an example of a first controller and a second controller. The composite circuit 115 generates a composite image that combines a plurality of images shot at various focus distances.

For example, the UAV control unit 30 derives a difference distance between a distance to a shooting target closest to the photographing device 100 with the focus distance ascertained and a distance when each of the plurality of shooting targets determined by the determination circuit 113 is shot. When the photographing device 100 includes a lens system where the magnification increases with increasing the focus distance, the UAV controller 30 can drive the propulsion unit 40 to allow the photographing device 100 to move along the shooting direction of the photographing device 100 away from the plurality of shooting targets by an amount of the difference distance when shooting each of the plurality of shooting targets. When the photographing device 100 includes a lens system where the magnification decreases with increasing the focus distance, the UAV controller 30 can drive the propulsion unit 40 to allow the photographing device 100 to move along the shooting direction of the photographing device 100 toward the plurality of shooting targets by an amount of the difference distance when shooting each of the plurality of shooting targets.

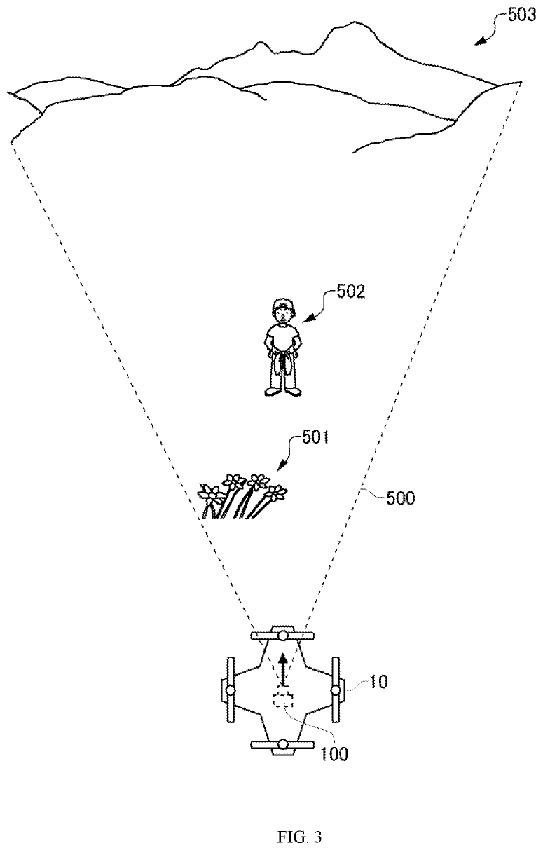

FIG. 3 shows an example of a positional relationship between a plurality of shooting targets shot by the photographing device 100 and the photographing device 100. In a shooting range 500 of the photographing device 100, there are a plurality of shooting targets 501, 502, and 503 having different distances from the photographing device 100. The shooting target 501 is a shooting target closest to the photographing device 100, for example, a flower. The shooting target 503 is a shooting target at a position infinity away from the photographing device 100, for example, a mountain. The shooting target 502 is a shooting target located between the shooting target 501 and the shooting target 503, for example, a person. Further, it is sufficient that at least two shooting targets are included in the shooting range 500 of the photographing device 100. The shooting range 500 of the photographing device 100 may include a shooting target at an infinity position and at least one shooting target closer to the photographing device 100 than the shooting target at the infinity position.

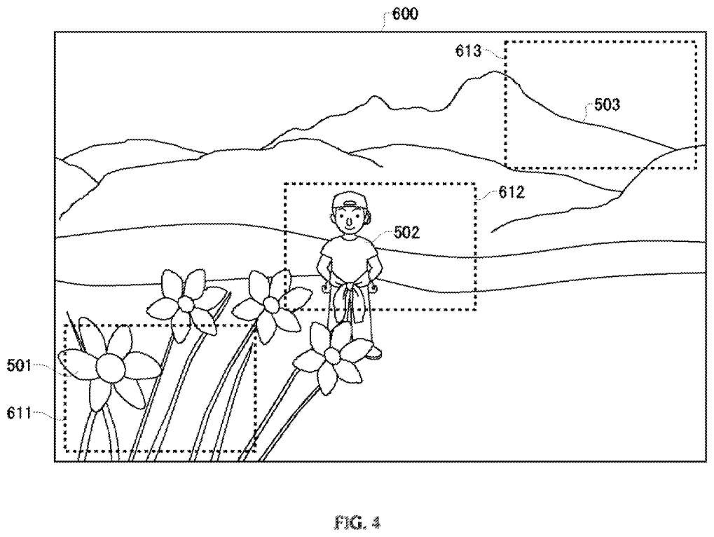

FIG. 4 is an example of an image 600 that is shot by the photographing device 100 and includes the plurality of shooting targets in the positional relationship shown in FIG. 3. The image 600 includes the shooting targets 501, 502, and 503 with different distances to the photographing device 100 in areas where the focus distances are derived, namely, a first area 611 at a lower left corner, a second area 612 at the center, and a third area 613 at a upper right corner.

For example, when the photographing device 100 shoots at a same position, an image focused at the first area 611, an image focused at the second area 612, and an image focused at the third area 613 have different magnifications. When the photographing device 100 includes a lens system where the magnification increases with increasing the focus distance, a magnification of the image focused at the third area 613 is greater than a magnification of the image focused at the first area 611. When the photographing device 100 includes a lens system where the magnification decreases with increasing the focus distance, a magnification of the image focused at the third area 613 is smaller than a magnification of the image focused at the first area 611. Therefore, according to the photographing device 100 mounted at the UAV 10 of the embodiments and the respective focus distance of the plurality of shooting targets, the distances between the photographing device 100 and the plurality of shooting targets are changed.

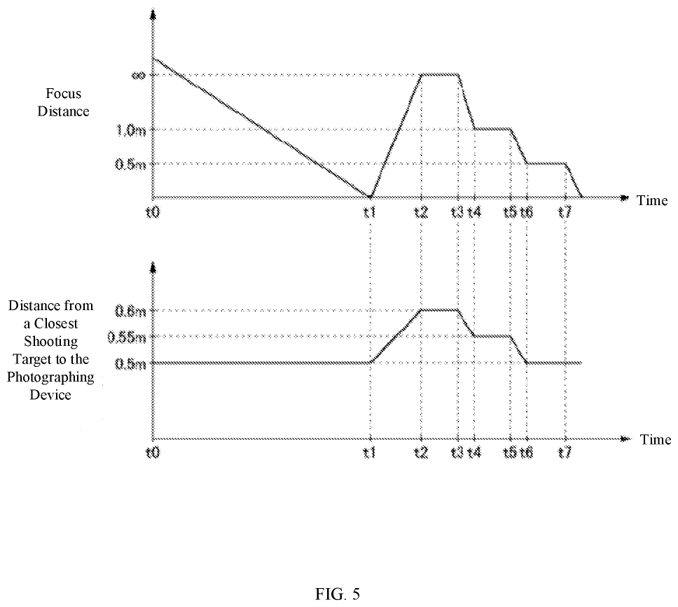

FIG. 5 shows an example of a correspondence relationship between a change of a focus distance of a photographing device 100 over time and a change of a distance between a closest shooting target and the photographing device 100 over time. FIG. 5 shows an example when the photographing device 100 includes a lens system where the magnification increases with increasing the focus distance.

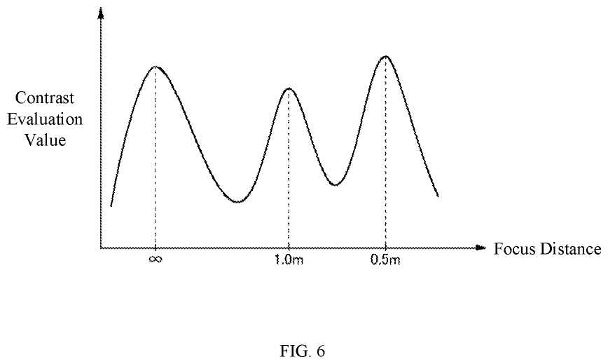

During the hovering of the UAV 10 at the first position, from time t0 to time t1, the focus distance is changed from the infinity side to the closest side, so that the photographing device 100 shoots a plurality of images. The photographing device 100 can derive the contrast evaluation value of each of the plurality of images. FIG. 6 shows the contrast evaluation values for various focus distances. In the example shown in FIG. 6, the peaks of the contrast evaluation values appear when the focus distance is infinity, 1.0 m, and 0.5 m. That is, there are shooting targets at positions of infinity, 1.0 m, and 0.5 m away from the photographing device 100.

In this scenarios, in order to focus at a shooting target at the infinity position for the photographing device 100 to shoot, the UAV 10 first moves to a position with a distance to the shooting target greater than the distance of the first position. For example, during a period from time t1 to time t2, the UAV 10 moves along the shooting direction of the photographing device 100 so that the distance to the closest shooting target is 0.6 m. During the period from time t1 to time t2, the photographing device 100 adjusts the lens position of the focus lens so that the focus distance is infinite.

During a period from time t2 to time t3, the UAV 10 hovers so that the distance to the closest shooting target is maintained at 0.6 m. During the period from time t2 to time t3, the photographing device 100 maintains the focus distance at infinity to shoot a plurality of images. During the period from time t2 to time t3, the photographing device 100 can maintain the focus distance at infinity to shoot a moving image.

During a period from time t3 to time t4, the UAV 10 moves along the shooting direction of the photographing device 100 so that the distance to the closest shooting target is 0.55 m. During the period from time t3 to time t4, the photographing device 100 adjusts the lens position of the focus lens so that the focus distance is 1.0 m.

During a period from time t4 to time t5, the UAV 10 hovers so that the distance to the closest shooting target is maintained at 0.55 m. During the period from time t4 to time t5, the photographing device 100 maintains the focus distance at 1.0 m to shoot a plurality of images. During the period from time t4 to time t5, the photographing device 100 can maintain the focus distance at 1.0 m to shoot a moving image.

During a period from time t5 to time t6, the UAV 10 moves along the shooting direction of the photographing device 100 so that the distance to the closest shooting target comes back to 0.5 m. During the period from time t5 to time t6, the photographing device 100 adjusts the lens position of the focus lens so that the focus distance is 0.5 m.

During a period from time t6 to time t7, the UAV 10 hovers so that the distance to the closest shooting target is maintained at 0.5 m. During the period from time t6 to time t7, the photographing device 100 maintains the focus distance at 0.5 m to shoot a plurality of images. During the period from time t6 to time t7, the photographing device 100 can maintain the focus distance at 0.5 m to shoot a moving image.

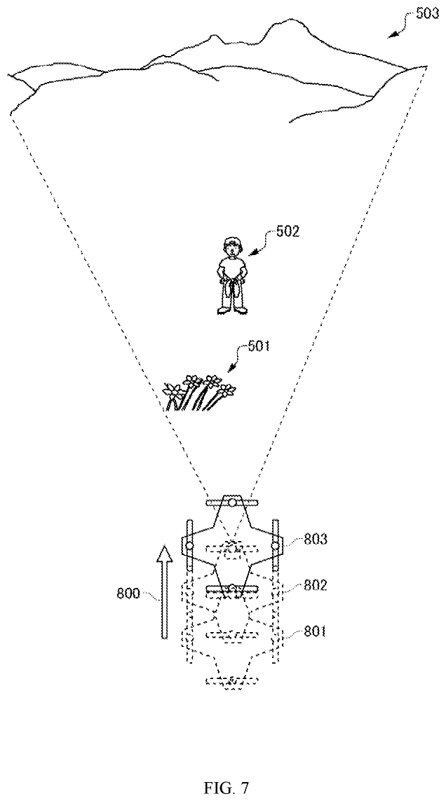

For example, as shown in FIG. 7, while the UAV 10 is moving, the photographing device 100 shoots a plurality of images. FIG. 7 shows an example when the photographing device 100 includes a lens system where the magnification increases with increasing the focus distance. In a state where the UAV 10 hovers at a position 803, the photographing device 100 changes the position of the focus lens to take a plurality of images. The obtaining circuit 112 obtains the focus distances corresponding to the shooting target 501, the shooting target 502, and the shooting target 503 based on the plurality of images. For example, the obtaining circuit 112 obtains 0.5 m, 1.0 m, and infinity as the focus distances corresponding to the shooting target 501, the shooting target 502, and the shooting target 503. The determination circuit 113 determines a distance from the photographing device 100 to the shooting target 501 when the focus distance is set to 0.5 m for shooting as 0.5 m. The determination circuit 113 determines a distance from the photographing device 100 to the shooting target 501 when the focus distance is set to 1.0 m for shooting as 0.55 m. The determination circuit 113 determines a distance from the photographing device 100 to the shooting target 501 when the focus distance is set to infinity for shooting as 0.6 m.

When the photographing device 100 shoots at the focus distance at which the shooting target 503 is in a focus state, the UAV 10 moves from the position 803 to a position 801. When the UAV 10 hovers at the position 803, the photographing device 100 sets the focus distance to infinity to shoot a plurality of images. For example, the UAV 10 moves so that the distance from the photographing device 100 to the shooting target 501 changes from 0.5 m to 0.6 m. The UAV 10 hovers at the position 801 to maintain the distance from the photographing device 100 to the shooting target 501 at 0.6 m. The photographing device 100 sets the focus distance to infinity to shoot a plurality of images.

The UAV 10 moves from the position 801 to a position 802 along a shooting direction 800 to approach the shooting target. For example, the UAV 10 moves so that the distance from the photographing device 100 to the shooting target 501 changes from 0.6 m to 0.55 m. The UAV 10 hovers at the position 802 to maintain the distance from the photographing device 100 to the shooting target 501 at 0.55 m. The photographing device 100 sets the focus distance to 1.0 m to shoot a plurality of images.

Further, the UAV 10 moves from the position 802 to the position 803 along the shooting direction 800 to approach the shooting target. For example, the UAV 10 moves so that the distance from the photographing device 100 to the shooting target 501 changes from 0.55 m to 0.5 m. The UAV 10 hovers at the position 803 to maintain the distance from the photographing device 100 to the shooting target 501 at 0.5 m. The photographing device 100 sets the focus distance to 0.5 m to shoot a plurality of images.

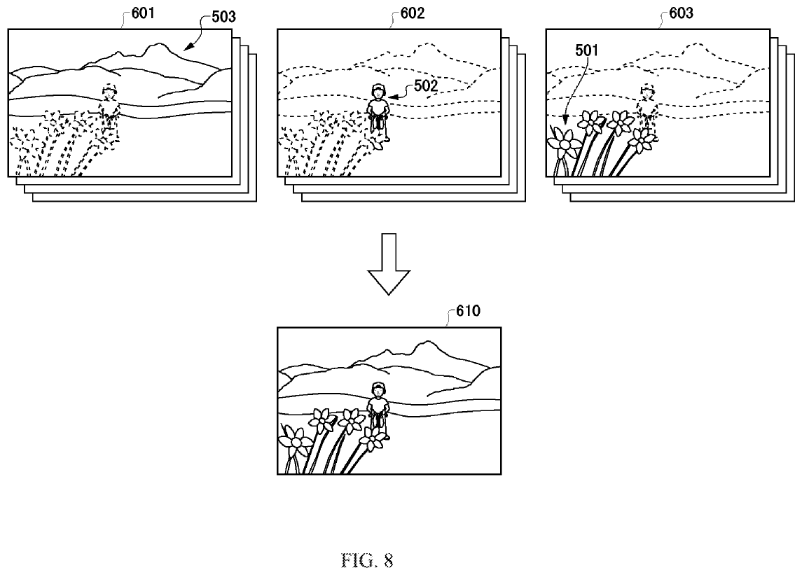

For example, as shown in FIG. 8, the photographing device 100 shoots a plurality of images 601 in a manner of focusing at the shooting target 502 whose distance to the photographing device 100 is infinite. The photographing device 100 shoots a plurality of images 602 in a manner of focusing at the shooting target 502 whose distance to the photographing device 100 is 1.0 m. The photographing device 100 shoots a plurality of images 603 in a manner of focusing at the shooting target 501 whose distance to the photographing device 100 is 0.5 m. The distance to the shooting target is changed while images are shot, so that the magnification change along with the change of the focus distance is eliminated. Therefore, the sizes of the shooting target 501, the shooting target 502, and the shooting target 503 included in the image 601, the image 602, and the image 603 are the same.

The composite circuit 115 selects one image 601 with a highest contrast evaluation value of the shooting target 503 from the plurality of images 601. The composite circuit 115 selects one image 602 with a highest contrast evaluation value of the shooting target 502 from the plurality of images 602. The composite circuit 115 selects one image 603 with a highest contrast evaluation value of the shooting target 501 from the plurality of images 603. The composite circuit 115 combines the selected image 601, image 602, and image 603 to generate a composite image, that is an image 610.

As a result, the contrast of each of the plurality of shooting targets included in the generated composite image is high. That is, it is possible to obtain a composite image with a deep depth of field. Further, according to the focus distances, the magnification of each shooting target included in the image does not change. Therefore, the relative size of each shooting target included in the composite image does not cause disharmony.

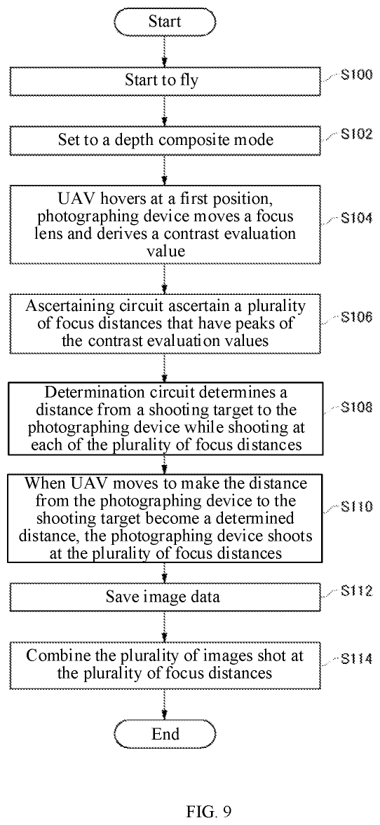

FIG. 9 is a flowchart of a shooting process of the photographing device 100 mounted at a UAV 10 according to an embodiment.

At S100, the UAV 10 starts to fly. The UAV 10 moves to a first position. The first position is a position at which a plurality of shooting targets can be shot by the photographing device 100. At S102, a user sets an imaging mode of the photographing device 100 to a depth composite mode through a remote operation device 300. When the UAV 10 arrives at the preset first position, the UAV controller 30 may automatically change the imaging mode of the photographing device 100 to the depth composite mode.

UAV 10 hovers at the first position. The imaging instruction circuit 114 instructs the imaging controller 110 to move a focus lens from an infinity side to a closest side. The imaging controller 110 moves the focus lens from the infinity side to the closest side through the lens controller 220. The imaging controller 110 causes the photographing device 100 to shoot a plurality of images while the focus lens is moving. At S104, the imaging controller 110 derives a contrast evaluation value of each of the plurality of images.

At S106, the ascertaining circuit 111 ascertains a plurality of focus distances that have peaks of the contrast evaluation values based on the contrast evaluation values derived by the imaging controller 110. At S108, the determination circuit 113 determines a distance from the photographing device 100 to a shooting target when the photographing device 100 shoots at each of the plurality of focus distances.

The UAV controller 30 moves the UAV 10 so that the distance from the photographing device 100 to the shooting target becomes the determined distance. At S110, during the movement of the UAV 10, the photographing device 100 shoots at focus distances. At S112, images shot by the photographing device 100 are saved in the memory 32.

At S114, the composite circuit 115 combines a plurality of images shot at the plurality of focus distances, and generates a composite image.

For example, the composite image may be displayed at a display unit included in an external device such as the remote operation device 300. The display unit may be surrounded by a frame and display an area including each shooting target whose focus distance is ascertained in the composite image. The composite circuit 115 may generate a composite image by using the area of each shooting target whose focus distance is ascertained in the composite image as a moving image.

Further, in the above-described embodiments, an example in which the focus distance of the photographing device 100 is changed by changing the lens position of the focus lens has been described. However, for example, the focus distance of the photographing device 100 may be changed by sequentially switching interchangeable lenses with different focal lengths. In addition, a plurality of photographing devices 100 including lens systems with different focal lengths may be mounted at the UAV 10, and the focus distance of the photographing device 100 can be changed by sequentially switching the plurality of photographing devices 100.

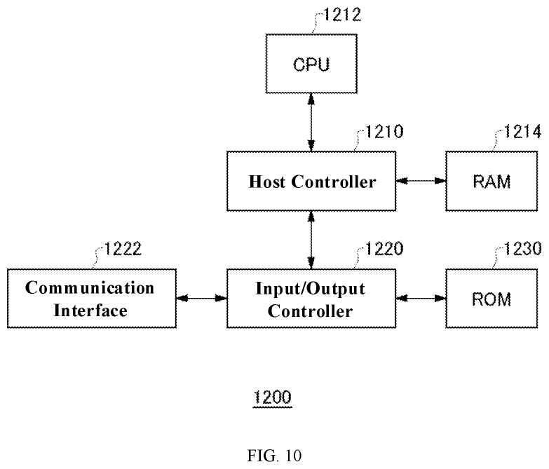

FIG. 10 shows an example of a computer 1200 that may embody one or more aspects of the present disclosure. The program installed on the computer 1200 can make the computer 1200 function as an operation associated with a device according to the embodiments of the present disclosure or one or more “units” of the device. In some embodiments, the program can cause the computer 1200 to perform the operation or the one or more “units.” The program enables the computer 1200 to execute a process or stages of the process consistent with embodiments of the present disclosure. The program can be executed by a CPU 1212 to make the computer 1200 execute specific operations associated with some or all of the blocks in the flowcharts or block diagrams described in this disclosure.

The computer 1200 of this disclosure includes the CPU 1212 and a RAM 1214, which are connected to each other through a host controller 1210. The computer 1200 further includes a communication interface 1222, an input/output unit, which is connected to the host controller 1210 through an input/output controller 1220. The computer 1200 also includes a ROM 1230. The CPU 1212 operates in accordance with programs stored in the ROM 1230 and RAM 1214 to control each unit.

The communication interface 1222 communicates with other electronic devices through a network. A hard disk drive can store programs and data used by the CPU 1212 of the computer 1200. The ROM 1230 stores a bootloader executed by the computer 1200 during operation, and/or a program dependent on the hardware of the computer 1200. The program is provided through a computer-readable medium such as a CR-ROM, a USB memory, or an IC card, or a network. The program is installed in the RAM 1214 or the ROM 1230, which are examples of computer-readable medium, and is executed by the CPU 1212. The information processing described in the programs is read by the computer 1200 and causes cooperation between the program and the various types of hardware resources described above. The device or method may be constituted by realizing the operation or processing of information with the use of the computer 1200.

For example, when a communication is performed between the computer 1200 and an external device, the CPU 1212 can execute a communication program loaded in the RAM 1214, and based on the processing described in the communication program, instruct the communication interface 1222 to perform communication processing. Under the control of the CPU 1212, the communication interface 1222 reads transmission data stored in a transmission buffer provided in a recording medium such as the RAM 1214 or a USB memory, and transmits the read transmission data to a network or writes received data received from the network in a receiving buffer provided in a recording medium.

Further, the CPU 1212 can make the RAM 1214 read all or required parts of files or databases stored in an external recording medium such as a USB memory, and perform various types of processing on the data of the RAM 1214. Then, the CPU 1212 can write the processed data back to the external recording medium.

Various types of information such as various types of programs, data, tables, and databases can be stored in the recording medium, and the information can be processed. For the data read from the RAM 1214, the CPU 1212 can execute various types of operations, information processing, conditional determination, conditional transfer, unconditional transfer, or information retrieval/replacement specified by the instruction sequence of the program described in the disclosure, and write the result back to the RAM 1214. In addition, the CPU 1212 can retrieve information in files, databases, or the like in the recording medium. For example, when a plurality of entries having attribute values of first attributes respectively associated with attribute values of second attributes are stored in the recording medium, the CPU 1212 may retrieve an entry that matches the condition that specifies the attribute value of the first attribute from the plurality of entries and read the attribute value of the second attribute stored in the entry to obtain the attribute value of the second attribute associated with the first attribute meeting a preset condition.

The programs or software modules described above may be stored at the computer 1200 or at a computer-readable storage medium near the computer 1200. In addition, a recording medium such as a hard disk or a RAM provided in a server system connected to a dedicated communication network or the internet can be used as a computer-readable storage medium to provide the program to the computer 1200 through the network.

The execution order of the actions, sequences, steps, and stages of the devices, systems, programs, and methods shown in the claims, specification, and drawings of the disclosure, can be implemented in any order as long as there is no special indication such as “before,” “in advance,” etc., and the output of the previous processing is not used in the subsequent processing. Regarding the operation procedures in the claims, the specification, and the drawings of the disclosure, the description is made using “first,” “next,” etc. for convenience, but it does not mean that the operations must be implemented in this order.

The present disclosure has been described above using embodiments, but the technical scope of the present disclosure is not limited to the scope described in the above embodiments. It is obvious to those skilled in the art that various changes or improvements can be made to the above-described embodiments. All such changes or improvements can be included in the scope of the present disclosure.

### REFERENCE NUMERALS

10—UAV 20—UAV Body 30—UAV Controller 32—Memory 36—Communication Interface 40—Propulsion Unit 41—GPS Receiver 42—Inertial Measurement Unit 43—Magnetic Compass 44—Barometric Altimeter 45—Temperature Sensor 46—Humidity Sensor 50—Gimbal 60—Photographing Device 100—Photographing Device 102—Photographing Unit 110—Imaging Controller 111—Ascertaining circuit 112—Obtaining Circuit 113—Determination Circuit 114—Imaging Instruction Circuit 115—Composite Circuit 120—Image Sensor 130—Memory 200—Lens Unit 210—Lens 212—Lens Driver 214—Position Sensor 220—Lens Controller 222—Memory 300—Remote Operation Device 500—Shooting Range 501, 502, 503—Shooting Target 1200—Computer 1210—Host Controller 1212—CPU 1214—RAM 1220—Input/Output Controller 1222—Communication Interface 1230—ROM

What is claimed is:

1. A determination device comprising:
a processor; and
a storage device storing instructions that, when executed by the processor, cause the processor to:
obtain a plurality of focus distances corresponding to a plurality of shooting targets included in a shooting range of a photographing device; and
determine a target distance between the photographing device and the plurality of shooting targets for the photographing device to shoot the plurality of shooting targets based on the plurality of focus distances.

2. The determination device of claim 1, wherein:
the photographing device includes a lens system in which a magnification increases with increasing focus distance;
the plurality of shooting targets include a first shooting target and a second shooting target, the first shooting target being closer to the photographing device than the second shooting target; and
the instructions further cause the processor to determine that the target distance between the photographing device and the plurality of shooting targets when the photographing device shoots the second shooting target is longer than the target distance between the photographing device and the plurality of shooting targets when the photographing device shoots the first shooting target.

3. The determination device of claim 1, wherein:
the photographing device includes a lens system in which a magnification decreases with increasing the focus distance;
the plurality of shooting targets include a first shooting target and a second shooting target, the first shooting target being closer to the photographing device than the second shooting target; and
the instructions further cause the processor to determine that the target distance between the photographing device and the plurality of shooting targets when the photographing device shoots the second shooting target is shorter than the target distance between the photographing device and the plurality of shooting targets when the photographing device shoots the first shooting target.

4. The determination device of claim 1, wherein the instructions further cause the processor to control the photographing device to shoot the plurality of shooting targets at each of the plurality of focus distances in a state where a distance between the photographing device and the plurality of shooting targets is set as the target distance.

5. The determination device of claim 1, wherein the instructions further cause the processor to:
change a lens position of a focus lens of the photographing device while maintaining the photographing device at an initial device position, and control the photographing device to shoot a plurality of images during change of the lens position; and
ascertain the plurality of focus distances for the plurality of shooting targets based on the plurality of images.

6. The determination device of claim 5, wherein the instructions further cause the processor to determine a difference between the target distance and a distance between the initial device position and the plurality of shooting targets to be smaller for one of the shooting targets that is closer to the photographing device than for another one of the shooting targets that is farther away from the photographing device.

7. The determination device of claim 6, wherein the instructions further cause the processor to determine the distance between the initial device position and the plurality of shooting targets to be the target distance between the photographing device and the plurality of shooting targets for shooting one of the shooting targets that is closest to the photographing device among the plurality of shooting targets.

8. An unmanned aerial vehicle (UAV) comprising the determination device of claim 5, wherein the instructions further cause the processor to control the UAV to hover at the initial device position.

9. The UAV of claim 8, wherein the instructions further cause the processor to move the lens position of the focus lens of the photographing device between an infinity side and a closest side while the UAV is hovering.

10. The UAV of claim 9, wherein the instructions further cause the processor to change each of distances between the photographing device and the plurality of shooting targets while the plurality of images are shot by controlling a movement of the UAV, so that a magnification change along with the change of the plurality of focus distances is eliminated.

11. A photographing system comprising:
a photographing device including a lens system with a focus lens; and
the determination device of claim 1.

12. The photographing system of claim 11, wherein the lens system includes a single focus lens.

13. A movable body comprising:
a photographing system including:
a photographing device including a lens system with a focus lens; and
a determination device including:
a processor; and
a storage device storing instructions that, when executed by the processor, cause the processor to:
obtain a plurality of focus distances corresponding to a plurality of shooting targets included in a shooting range of the photographing device; and
determine a target distance between the photographing device and the plurality of shooting targets for the photographing device to shoot the plurality of shooting targets based on the plurality of focus distances; and
a controller configured to control the movable body to move so that a distance between the photographing device and the plurality of shooting target is the target distance.

14. The movable body of claim 13, wherein:
a magnification of the lens system increases with increasing focus distance;
the plurality of shooting targets include a first shooting target and a second shooting target, the first shooting target being closer to the photographing device than the second shooting target; and
the instructions further cause the processor to determine that the target distance between the photographing device and the plurality of shooting targets when the photographing device shoots the second shooting target is longer than the target distance between the photographing device and the plurality of shooting targets when the photographing device shoots the first shooting target.

15. The movable body of claim 13, wherein:
a magnification of the lens system decreases with increasing the focus distance;
the plurality of shooting targets include a first shooting target and a second shooting target, the first shooting target being closer to the photographing device than the second shooting target; and
the instructions further cause the processor to determine that the target distance between the photographing device and the plurality of shooting targets when the photographing device shoots the second shooting target is shorter than the target distance between the photographing device and the plurality of shooting targets when the photographing device shoots the first shooting target.

16. The movable body of claim 13, wherein the instructions further cause the processor to control the photographing device to shoot the plurality of shooting targets at each of the plurality of focus distances in a state where a distance between the photographing device and the plurality of shooting targets is set as the target distance.

17. The movable body of claim 13, wherein the instructions further cause the processor to:
change a lens position of a focus lens of the photographing device while maintaining the photographing device at an initial device position, and control the photographing device to shoot a plurality of images during change of the lens position; and
ascertain the plurality of focus distances for the plurality of shooting targets based on the plurality of images.

18. The movable body of claim 17, wherein the instructions further cause the processor to determine a difference between the target distance and a distance between the initial device position and the plurality of shooting targets to be smaller for one of the shooting targets that is closer to the photographing device than for another one of the shooting targets that is farther away from the photographing device.

19. The movable body of claim 18, wherein the instructions further cause the processor to determine the distance between the initial device position and the plurality of shooting targets to be the target distance between the photographing device and the plurality of shooting targets for shooting one of the shooting targets that is closest to the photographing device among the plurality of shooting targets.

20. A composite system comprising:
a processor; and
a storage device storing instructions that, when executed by the processor, cause the processor to:
obtain a plurality of focus distances corresponding to a plurality of shooting targets included in a shooting range of a photographing device;
determine a target distance between the photographing device and the plurality of shooting targets for the photographing device to shoot the plurality of shooting targets based on the plurality of focus distances;
control the photographing device to shoot the plurality of shooting targets at each of the plurality of focus distances in a state where a distance between the photographing device and the plurality of shooting targets is set as the target distance to obtain a plurality of images; and
combine the plurality of images.
